(19) United States
(12) Patent Application Publication
(10) Pub. No.: US 2002/0019765 A1
(43) Pub. Date: Feb. 14, 2002

(54) Performance measurement and management

(76) Inventors: Robert Mann, London (GB); Elizabeth Bryant, Surrey (GB); Alberto Gonzalez, London (GB); Siegfried Hoenle, Daellikon (CH)

Correspondence Address: Clifford Chance Rogers & Wells LLP, 200 Park Avenue, New York, NY, 10166-0153, US

(21) Appl. No.: 09/841,219

(22) Filed: Apr. 24, 2001

Related U.S. Application Data
(60) Provisional application No. 60/200,559, filed on Apr. 28, 2000.

(51) Int. Cl. G06F 17/60

(52) U.S. Cl. 705/11

(57) ABSTRACT

A method is provided for providing performance assessment of an employee, a service, a product or a vendor “an evaluatee” and includes the step of accessing an online performance measurement program on a distributed network access device. Next, an online 90 degree or 360 degree evaluation is created. Next, an online self evaluation is completed. Next, an elected evaluation is completed. Next, the results of the evaluations are aggregated. Finally, feedback relating to the evaluation is sent to the evaluatee or other nominated recipients.

### CROSS-REFERENCE TO RELATED APPLICATION

This application claims the benefit of the filing date of U.S. provisional application Ser. No. 60/200,559 entitled “Performance Measurement And Management,” which was filed on Apr. 28, 2000.

### BACKGROUND

This invention relates to a method and system for providing human resource performance measurement and the management of personnel. In particular, the present invention relates to an automated system and method for performing and monitoring 90 degree and 360 degree evaluations for personnel at diverse geographic locations through the use of an electronic communications network.

A productive workforce is a major factor in an organization's success. To gauge the effectiveness of its workforce, organizations generally assess the performance of each employee in the organization against identified goals and objectives. Based on the nature of the employee's performance with respect to such goals, the organization then determines which employees should be promoted and given more responsibility, the increase/reduction in compensation appropriate for each employee and whether a particular employee is not contributing to the organization's success. By promoting and compensating employees that perform well and weeding out those that do not, the organization will develop a motivated and productive workforce.

Prior art employee performance appraisal systems exist that are used for quantifying the performance of employees. For example, U.S. Pat. No. 6,119,097 entitled “System and Method for Quantification of Human Performance Factors” and issued to Ibarra, provides a method in which a supervisor uses an employee problem-solving worksheet displayed on a computer display to identify objective standards for the employee. At least one objective activity that should enable the employee to meet the objective standards is identified and assigned to the employee. The supervisor then completes monthly evaluations of the employee to determine whether or not the objective activities are being accomplished and, if so, whether the employee is at least meeting the objective standards. Such performance appraisal systems that include information only from an employer's manager are called 90 degree systems.

A recent trend in employee performance appraisals are the so called 360 degree performance appraisals in which performance information concerning each employee being rated is gathered from coworkers and direct reports as well as from supervisors. (See, for example, U.S. Pat. No. 5,926,794 entitled “Visual rating system and method” and issued to Fethe). The 360 degree performance appraisals provide benefits over 90 degree performance appraisal systems by placing an increased emphasis on teamwork and by providing individuals within the organization with a voice in the performance appraisal of employees who service them. In addition, the 360 degree performance appraisal system provides a more balanced review of an employee that is less influenced by personal biases of any single evaluator.

As organizations grow and become geographically dispersed, it becomes increasingly difficult for the organization to coordinate the performance review process of all its employees in an efficient and timely manner. This is especially the case for 360 degree reviews that often rely on information from numerous evaluators that may be in different locations than each other and the evaluatee. Furthermore, because in geographically dispersed organizations the evaluators and evaluatees often speak different languages, it is important that a performance appraisal system enables evaluators and evaluatees to provide performance assessments regardless of the native language of the assessment provider.

Accordingly, it is desirable to provide a method and system for performing and monitoring 90 degree and 360 degree employee performance appraisals in a geographically dispersed organization.

### SUMMARY OF THE INVENTION

The present invention is directed to overcoming the drawbacks of the prior art. Under the present invention, a method is provided for providing performance measurement of an evaluatee and includes the step of accessing an online performance measurement program on a distributed network access device. Next, an online 90 degree or 360 degree evaluation is evaluated. Next, an online self evaluation is completed. Next, an elected evaluation is completed. Next, the results of the evaluations are aggregated. Finally, feedback relating to the evaluation is sent to the evaluatee.

In an exemplary embodiment, objectives for an evaluation period are set and the objectives are recorded in the computer implementing the system.

In another exemplary embodiment, a digital signature to a report containing the aggregated results is applied.

In yet another embodiment, a to do list is generated that includes outstanding tasks relating to completion of the performance measurement and a listing of completed tasks are also generated.

In still yet another embodiment, compensation and promotion processes are linked to the evaluation.

In an exemplary embodiment, an interaction with the computer system implementing the performance measurement is accomplished in multiple languages.

In another exemplary embodiment, evaluators are selected from a list of appropriate personnel relative to the evaluatee.

In yet another exemplary embodiment, the evaluations include contribution and competency categories.

In still yet another exemplary embodiment, the competency category comprises detail ratings.

Under the present invention, computer system for providing performance measurement of an evaluatee is provided and includes a computer server accessible with a network access device via a communications network wherein executable software that is executable on demand via the network access device is stored on the server. The software is operative with the server to cause access to an online performance measurement program on a distributed network access device; the election of an online 90 degree or 360 degree evaluation; the completion of an online self evaluation; the completion of an elected evaluation; aggregation of the results of the evaluations; and the sending of feedback relating to the evaluation to the evaluatee.

In an exemplary embodiment, the network access device comprises a computer and the communication network conforms to the transmission control protocol/internet protocol.

In another exemplary embodiment, the computer communication network comprises an intranet and additionally comprises a WEB interface for accessing the executable software stored on the server storage medium. Under the present invention, a system for providing a performance evaluation is provided and includes an interface module for presenting to an evaluator an evaluation form in a first language, wherein the evaluator inputs evaluation information regarding an evaluatee into the evaluation form. An evaluation data database for storing the evaluation information is included. Also included is a feedback generator for retrieving the evaluation information from the evaluation data database and placing the evaluation information into a feedback form. The interface module then presents the feedback form to the evaluates in a second language.

In an exemplary embodiment, the evaluator inputs comments in the first language and the evaluatee is presented with the feedback form in the second language and the comments in the first language.

In another exemplary embodiment, the evaluatee inputs comments in the second language and the evaluator is present with the feedback form in said first language and the comments in the second language.

In yet another exemplary embodiment, an evaluation management module for monitoring the evaluation information in said evaluation data database is included and generates status information regarding the performance evaluation.

In still yet another exemplary embodiment, the status information includes to do information and completion data information .

In an exemplary embodiment, the status information is communicated via electronic mail or facsimile.

Under the present invention, a method for providing a performance evaluation is provided and includes the step of presenting to an evaluator an evaluation form in a first language. Next, evaluation information regarding an evaluatee is received from the evaluator via the evaluation form. Next, the evaluation information is stored into an evaluation data database. Next the evaluation information is retrieved from the evaluation data database and placed into a feedback form. Finally, the feedback form is presented to the evaluatee in a second language.

Accordingly, a system and method is provided for performing and monitoring 90 degree and 360 degree employee performance appraisals in a geographically dispersed organization.

### DESCRIPTION OF THE DRAWINGS

FIG. 1 illustrates the components of a computer network system;

FIG. 2 is a block diagram of the PMM system of the present invention;

FIG. 3 is a flow diagram describing the operation of the PMM system of FIG. 2;

FIG. 4 is a screenshot of a self evaluation form used in the system of FIG. 2 according to an exemplary embodiment;

FIG. 5 is a screenshot of a manager evaluation form used in the system of FIG. 2 according to an exemplary embodiment;

FIG. 6 is a screenshot of an objectives form used in the system of FIG. 2 according to an exemplary embodiment;

FIG. 7 is a screenshot of a feedback form used in the system of FIG. 2 according to an exemplary embodiment;

FIG. 8 is a screenshot of a to do form used in the system of FIG. 2 according to an exemplary embodiment;

FIG. 9 is a screenshot of a track progress form used in the system of FIG. 2 according to an exemplary embodiment;

FIG. 10 is a screenshot of a completion data form used in the system of FIG. 2 according to an exemplary embodiment;

FIGS. 11a and 11b are screenshots multilingual evaluation forms used in the system of FIG. 2 according to an exemplary embodiment;

FIG. 12 is a screenshot of a vendor evaluation form used in the system of FIG. 2 according to an exemplary embodiment; and

FIG. 13 is a screenshot of a set-up evaluation tool used to “configure”, design, and build an assessment structure which is then initialized to generate a company specific assessment system according to an exemplary embodiment.

### DETAILED DESCRIPTION OF THE PREFERRED EMBODIMENTS

A Performance Measurement and Management (PMM) system and method can provide a tool to perform a human resources, technical, or other evaluation via a computer communications network. Evaluations can be performed from diverse geographic locations and include evaluators who are within a 90 degree and/or 360 degree organizational position in relation to the person being evaluated. Participants in the evaluation process can access the PMM via a communications network, such as an intranet or the Internet, with a network access device, such as a computer.

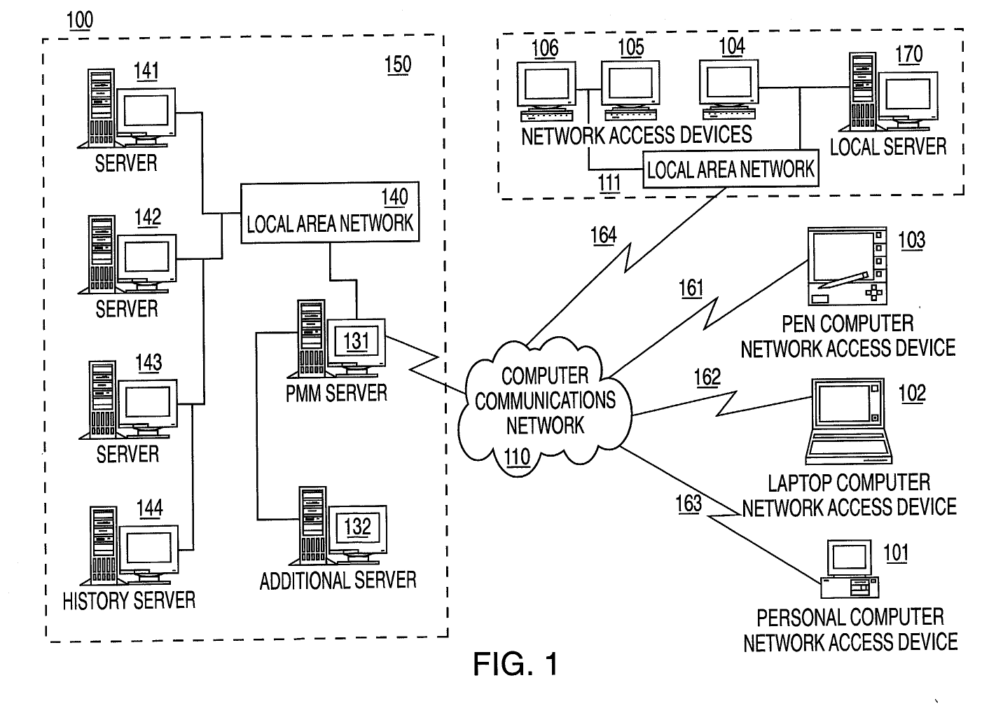

FIG. 1 shows a network of computers 100 that may be used in an implementation of a PMM system. The network 100 includes a host system 150 and evaluator computers 101-106. Each of the evaluator computers can include a processor, memory, user input device, such as a keyboard and/or mouse, and a user output device, such as a video display and/or printer. The evaluator computers 101-106 can communicate with the host 150 to obtain data stored at the host 150, such as employee data or position description data, as well as data quantifying a history of evaluatee performance. The evaluator computer 101-107 may interact with the host computer 150 as if the host was a single entity in the network 100. However, the host 150 may include multiple processing and database sub-systems, such as cooperative or redundant processing and/or database servers 141-144, that can be geographically dispersed throughout the network 100. In some implementations, groups of evaluator computers 104-106 may communicate with host 150 through a local server 170. The local server 170 may be a proxy server or a caching server. Server 107 may also be a co-host server that can serve PMM content and provide functionality such as evaluation forms and feedback reports to evaluator computers 104-106.

An evaluator can access the host 150 using communications software executed at an evaluator computer 101-107. The communications software may include a generic hypertext markup language (HTML) browser, such as Netscape Navigator or Microsoft Internet Explorer (a “WEB browser”), executable routines such as “dots”, standard queries, or other known means for accessing data over a computerized communications network. The evaluator software may also be a proprietary browser, and/or other host access software. In some cases, an executable program, such as a Java™ program, may be downloaded from the host 150 to the evaluator computer and executed at the evaluator computer as part of the on-line PMM evaluation.

A Performance Measure and Management (PMM) method and system can consistently measure and reward an employee's, or other evaluatee's, performance on a global basis. In addition, PMM can provide clarity to the evaluatee on what their performance will be measured against, as well as feedback mechanisms quantifying past performance. PMM can be used to identify strengths or development needs. In one embodiment PMM can be used to inform compensation and/or job promotion, decision-making processes regarding an evaluatee's performance. Compensation and promotion decision-making processes can be automated or accomplished through traditional human interaction. For example, an evaluatee can be nominated for promotion with an appropriate ranking and completion of the evaluation form. In addition, the system can be used to prompt a manager to promote an evaluatee based upon the evaluatee's performance. PMM can also be used to link individual worker objectives to a particular corporate strategy or goal. An evaluatee can also be involved in setting subsequent objectives, which will be utilized in future, evaluations.

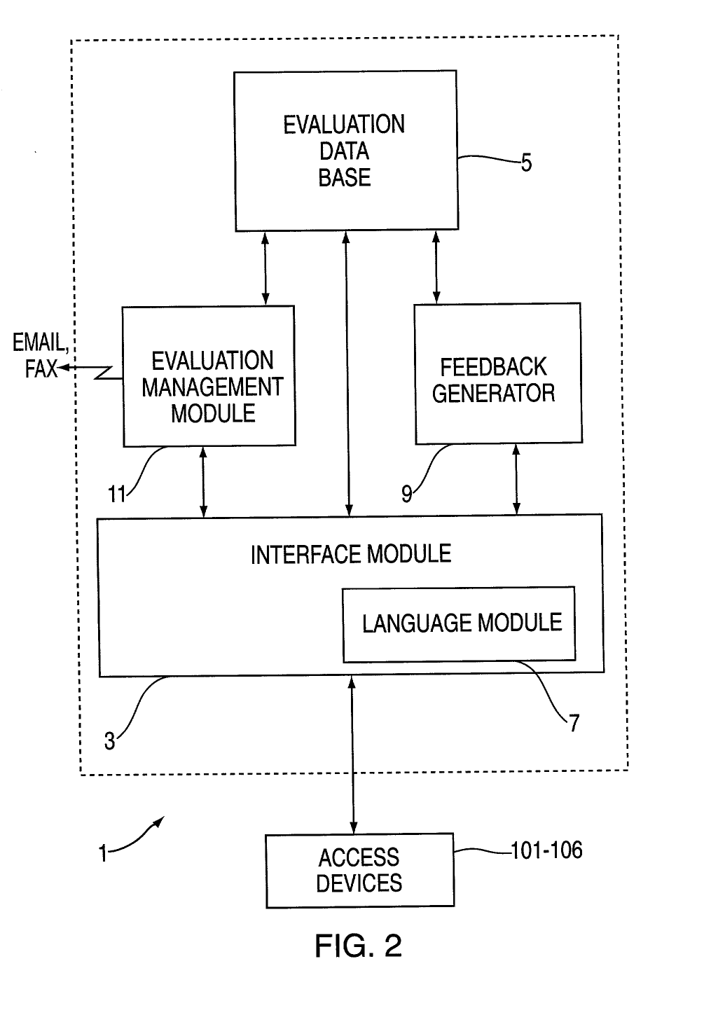

Referring now to FIG. 2, there is shown a block diagram of a PMM system 1 of the present invention. In an exemplary embodiment, system 1 runs on host system 150 and includes an interface module 3 that provides evaluators operating any of computers 101-106 with access to the performance measuring and monitoring services provided by system 1. Evaluators provide performance evaluation information to system 1 through a variety of forms that are displayed on the display screen of any of computers 101-106. Interface module 3 includes a language manager 7 that allows users to configure the forms to include prompts and labels in their native language. Evaluation information received from geographically dispersed evaluators is centrally stored in an evaluation data database 5 thereby simplifying the analysis of employee performance throughout the organization. System 1 also includes a feedback generator 9 that retrieves all the evaluation information regarding a particular employee from evaluation database 5 and presents such information to the employee in a composite format. In addition, system 1 includes an evaluation management module 11 that monitors the progress of the 90 degree and 360 degree evaluations by accessing the evaluation information stored in evaluation data database 5 and reports on the status of such evaluations to the appropriate individuals. Evaluation management module 11 may report such status via interface module 3 or using any other means including, by way of non-limiting example, electronic mail or facsimile.

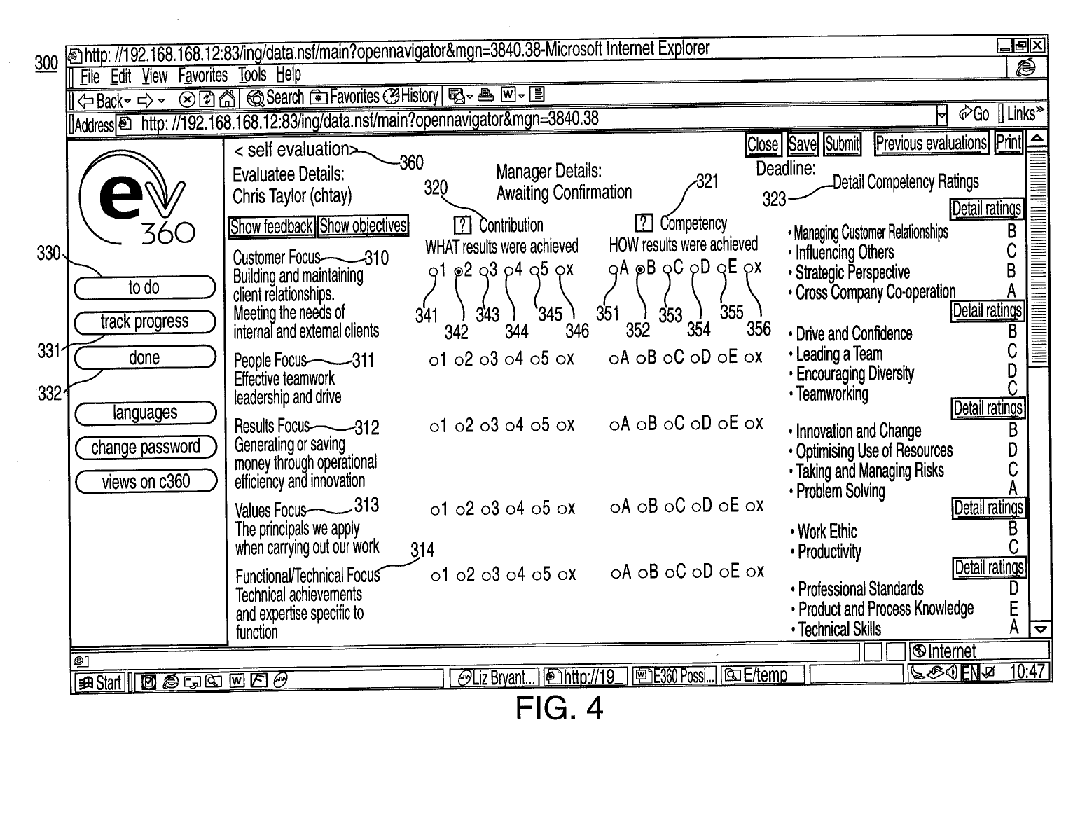

Referring now to FIG. 4, there is shown a screenshot of self evaluation form 300 through which an employee provides self-evaluation information to system 1. In this example performance is measured by evaluating the contribution and competency of the evaluatee in key areas. Key areas can include criteria important to evaluatee's position the importance of which may be based upon the needs of the company and/or the developmental needs of the evaluatee. For example, self evaluation screen 300 may include entries for evaluation data relating to various areas of performance to be evaluated such as, by way of non-limiting example, customer focus 310, people focus 311, results focus 312, values focus 313 and functional/technical focus 314. Customer area 310 may request evaluation information regarding the employee's strategic and global perspective, the ability to manage client relationships and services, networking and influencing, and cross product cooperation. People focus area 311 may request evaluation information regarding the employee's ability to build and lead a team, teamwork, drive and commitment, and promoting of diversity. Results focus area 312 may request information regarding the evaluatee's ability to innovate and continuously improve, problem solving and decision-making capabilities and the ability to leverage resources and manage risk. Functional/technical focus area 314 may request evaluation information regarding the evaluatee's professional behavior, product and process knowledge, and business and technical expertise. It will be obvious based on the above to include other key areas to be evaluated based on the responsibilities and expectations associated with a position in an organization. In exemplary embodiment, self evaluation form 300 includes an overall rating aggregating the performance provided by the evaluatee for each of the key evaluation areas.

Functional interaction with the self evaluation form 300 can be accomplished via a graphical user interface (GUI) or other interactive medium operative with a network access device. In an exemplary embodiment, self-evaluation form 300 includes an interactive device allowing an evaluator to scale an evaluation. Such interactive devices may include, by way of non-limiting example, check boxes, bull's eyes, yes/no fields, scaled entries, or other easily understood and implemented devices.

Evaluation performance is measured by identifying the evaluatee's contribution 320 with respect to each of key areas 310-314. In this example an evaluatee's contribution to a key area may be measured against objectives using a five-point rating scale. For example, a one rating 341 can indicate performance, which far exceeded expectations, wherein all objectives were met and all targets were significantly exceeded. A two rating 342 can be used to represent exceeded objectives wherein all objectives were met and some targets were significantly exceeded. A three rating 343 can represent objectives fully met wherein all objectives and targets were met. A four rating 344 can indicate that objectives were partially met wherein some objectives and targets were met. A five rating 345 in this scale would indicate that objectives were not met, wherein few or none of the set objectives and targets were met. In addition, an ‘X’ rating 346 can be used to indicate that the rating is not applicable, wherein contribution in this performance area is not required by the particular role of the evaluatee. In this manner, evaluatee contributions and/or results the evaluatee has accomplished can be accurately and consistently quantified on a global basis.

In addition, a competency measure 321 indicating how an evaluatee achieved results in each of key areas 310-314 can be measured against performance standards on a scaled basis 351-356. Performance standards for competency can be used as a guide for those behaviors that are important to an evaluatee's position and should be evaluated. A scale used to rate competency 321 can include an ‘A’ rating 351 indicating that the evaluatee transfers competency, wherein the evaluatee leverages competency and actively and successfully develops competencies in others.

A ‘B’ rating 352 can indicate that the evaluatee leverages competency, wherein behaviors are demonstrated at an appropriate time and the evaluatee understands when this competency is critical to success and consciously decides when to apply it to deliver business results. A ‘C’ rating 353 can indicate that the evaluatee demonstrates competency. Demonstrating competency involves effectively applying relative behaviors described in performance standards. A ‘D’ rating 354 can indicate that competency is yet to be developed. An evaluates earning a ‘D’ rating 354 would partially demonstrate a competency but some behaviors are insufficiently developed or are demonstrated infrequently, or inappropriately. An ‘E’ rating 355 can be used to indicate that the competency is not demonstrated. An ‘E’ rating 355 suggests that most or all behaviors for this competency are not demonstrated or demonstrated very infrequently. In addition, an ‘X’ rating 356 can be used where the competency is not applicable, wherein demonstration of this competency is not required by the role or there is insufficient performance information to determine a rating.

Evaluation form 300 can also include areas to input a detailed competency rating 323 for each of key areas 310-314. In addition, evaluation screen 300 may also include an area where additional comments regarding the accomplishments and strengths of the evaluatee may be entered. Evaluation form 300 can also include interactive devices to launch functionalities included in system 1 including, by way of non-limiting example, a to-do list 330, a track progress tool 331, a done view 332, as well as a feedback view, various administrative tasks and a help section. Finally, the title header 360 on the evaluation screen as shown in FIG. 4 indicates that this is a self-evaluation screen.

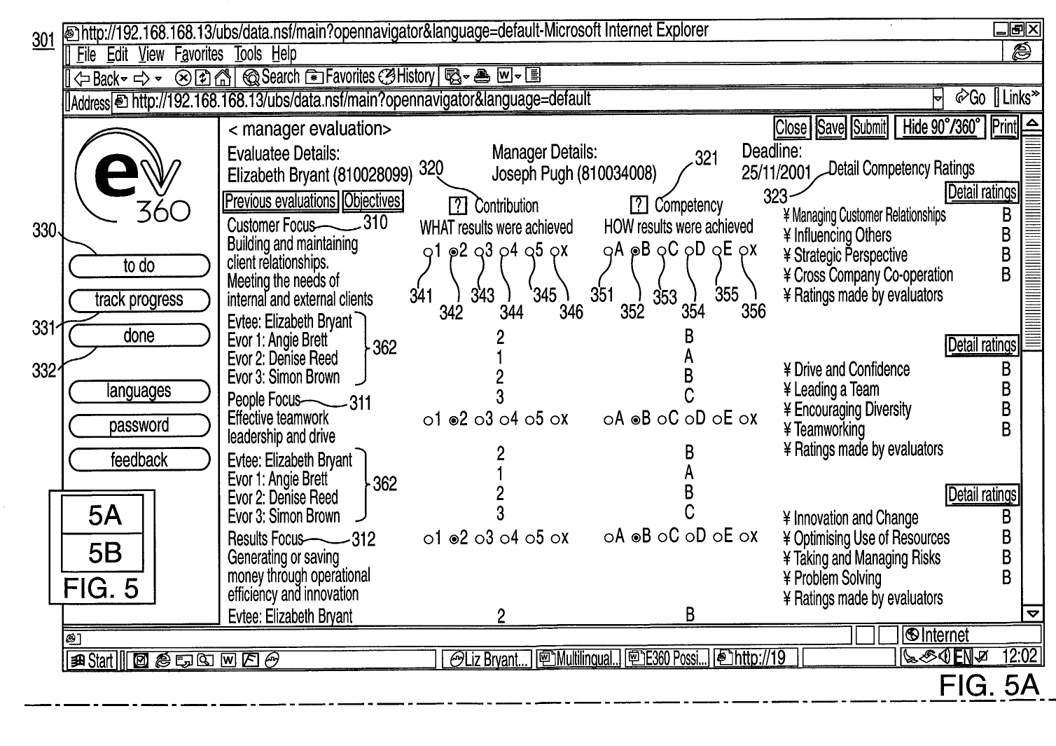

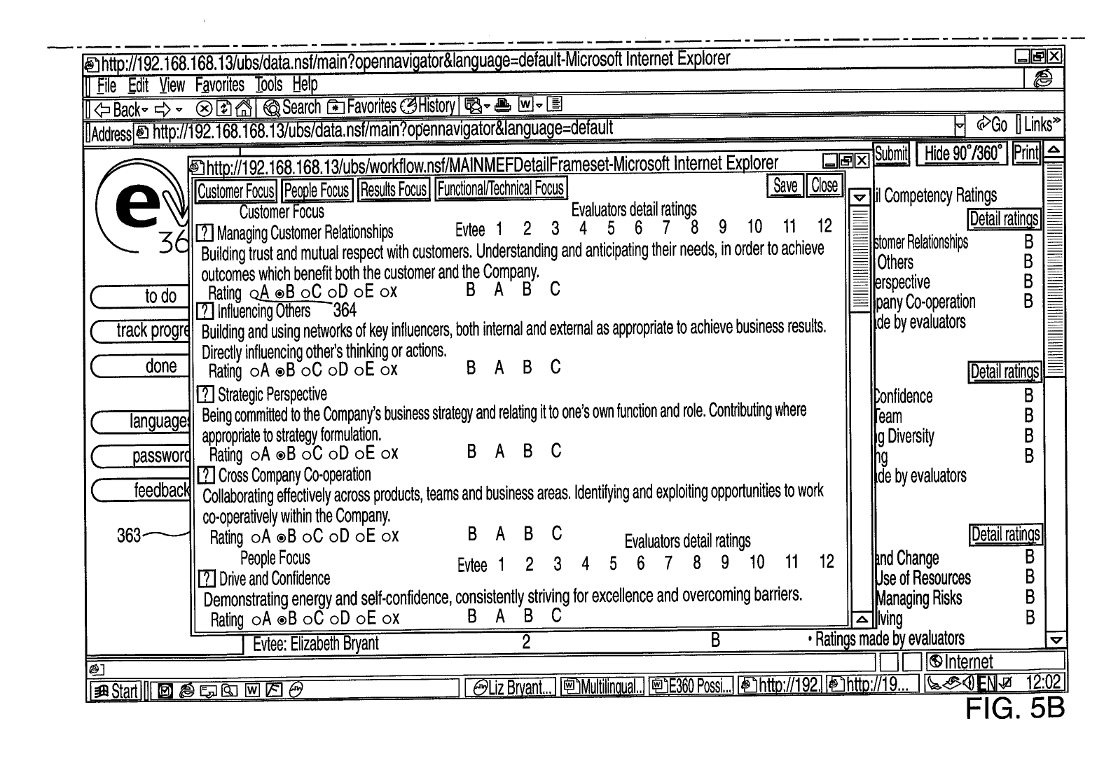

Referring now to FIG. 5, there is shown a screenshot of manager evaluation form 301 through which a manager provides system 1 evaluation information pertaining to a particular employee. Elements that are similar to elements in evaluation form 300 of FIG. 4 are identically labeled and a detailed description thereof is omitted.

Manager evaluation form 301 includes a evaluation summary section 362 in which the manager can view the performance rating provided by the employee evaluatee as well as any additional evaluators. For example, with respect to rating regarding the evaluatee's customer focus 310, the evaluatee gave a self-evaluation of 2, evaluator 1 a rating of 1, evaluator 2 a rating of 2 and evaluator 3 a rating of 3. Thus, the manager may review the other ratings provided for the particular evaluatee before the manager issues a rating.

With respect to providing detail competency ratings 323, the evaluator may activate a pop-up screen 363 that lists each of the areas within detail competency ratings 323 and provides the evaluator with an entry mechanism 364 such as, by way of non-limiting example, a series of bull's eyes for entering a rating.

In addition to self evaluation form 300 and manager evaluation form 301, it will be obvious based on the above to provide additional evaluation forms for evaluations to be provided from a variety of sources for example by peers, internal clients, external clients, direct reports or additional managers.

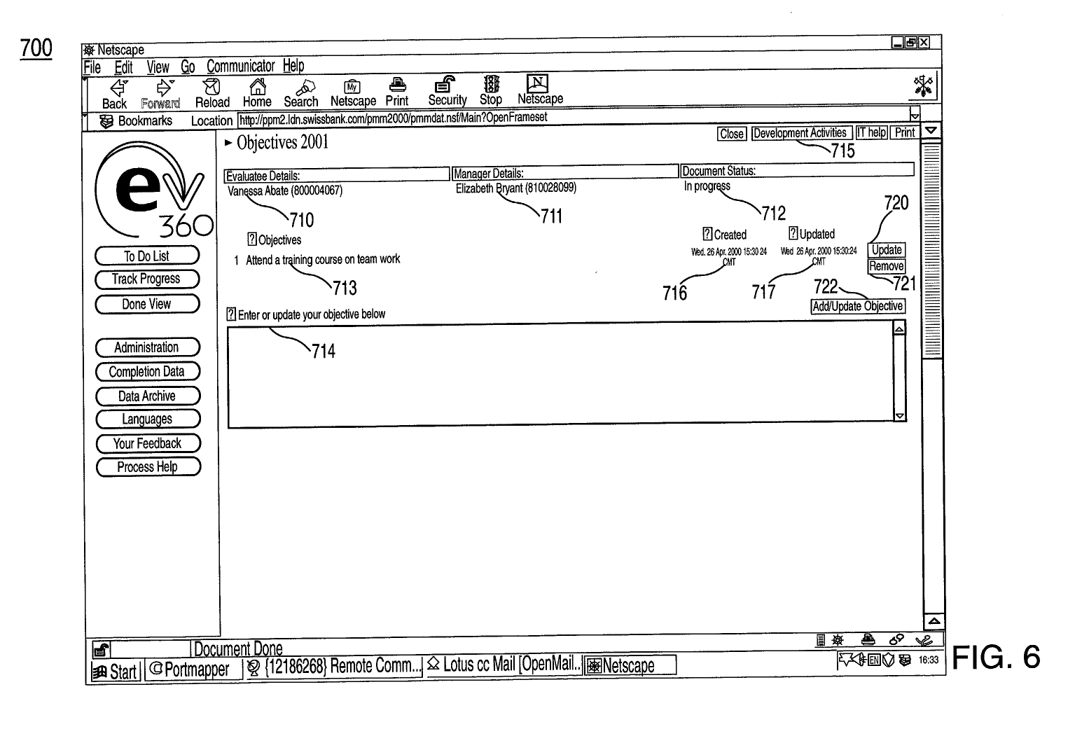

Referring now to FIG. 6, there is shown a screenshot of an objectives form 700 through which objectives for an upcoming evaluation period may be entered. In an exemplary embodiment, objectives form 700 includes evaluatee identification 710, manager identification 711 and document status 712. In addition, objectives form 700 may include a text area 714 in which specific objectives to be accomplished during an upcoming or present evaluation period may be entered, a created field 716 indicating when the particular objective was created, and an updated field 717 indicating when the particular objective was last updated. Programmable interactive devices 720-722 may be used to cause the update, removal and addition of an objective, respectively.

Evaluation information received by interface module 3 is then forwarded to evaluation data database 5. Evaluation data database 5 aggregates evaluation information from all evaluators across a geographically dispersed organization thereby enabling an organization to evaluate the performance of each employee both with respect to identified goals and in comparison to other employees. Evaluation data database 5 organizes all the evaluation information regarding a particular employee in logical groups using known database techniques such as, by way of non-limiting example, linked lists. For example, if a particular employee is being evaluated in a 360 degree evaluation by one manager, five peers and two direct reports, then these eight evaluations, plus the employee's self-evaluation are all logically connected within evaluation data database 5. In this way, the status of each evaluation can be easily monitored and the performance of each employee can be effectively analyzed.

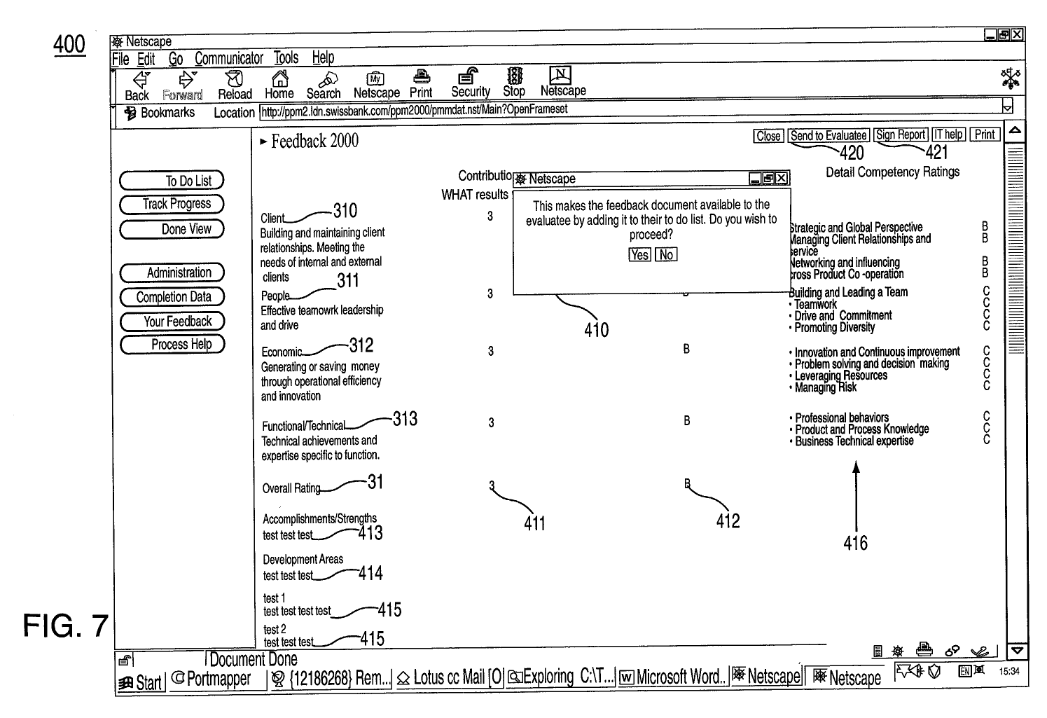

Referring now to FIG. 7, there is shown a screenshot of a feedback form 400 according to an exemplary embodiment through which the evaluates receives feedback from the evaluators. Feedback generator 9 retrieves all evaluation information related to a particular employee from evaluation data database 5 and organizes such evaluation information into a composite format, such as the exemplary format shown in feedback form 400. Feedback relating to an evaluation can be presented on a display associated with an interactive device, printed on hardcopy, communicated with digital audio, video stream other known communications means. Feedback can be controlled by a manager, or other supervisory personnel, wherein the manager can be presented with an interactive device, such as a yes/no screen 410 prompting a manager to make feedback form 400 available to the evaluatee.

Feedback form 400 can include key areas 310-313 and an overall rating 315. An aggregation of evaluation results can be calculated and displayed according to key area and function, such as contribution and competency. For example, one column of scaled ratings 411 can show the aggregation of contribution evaluations and another column 412 can display aggregate scaled ratings relating to competency. To further support the aggregate ratings 411-412, details of the evaluation can be shown 416. An area can be provided to quantify accomplishments and strengths of the evaluatee 413, as well as an area to quantify necessary developments 414. Other areas can be provided according to the specific needs on an organization or evaluates 415.

Additional programmable interactive devices can also be included, such as a device to send the feedback to the evaluatee, or a device to sign the report 421. As mentioned above, a digital signature can be utilized to further automate the system if desired.

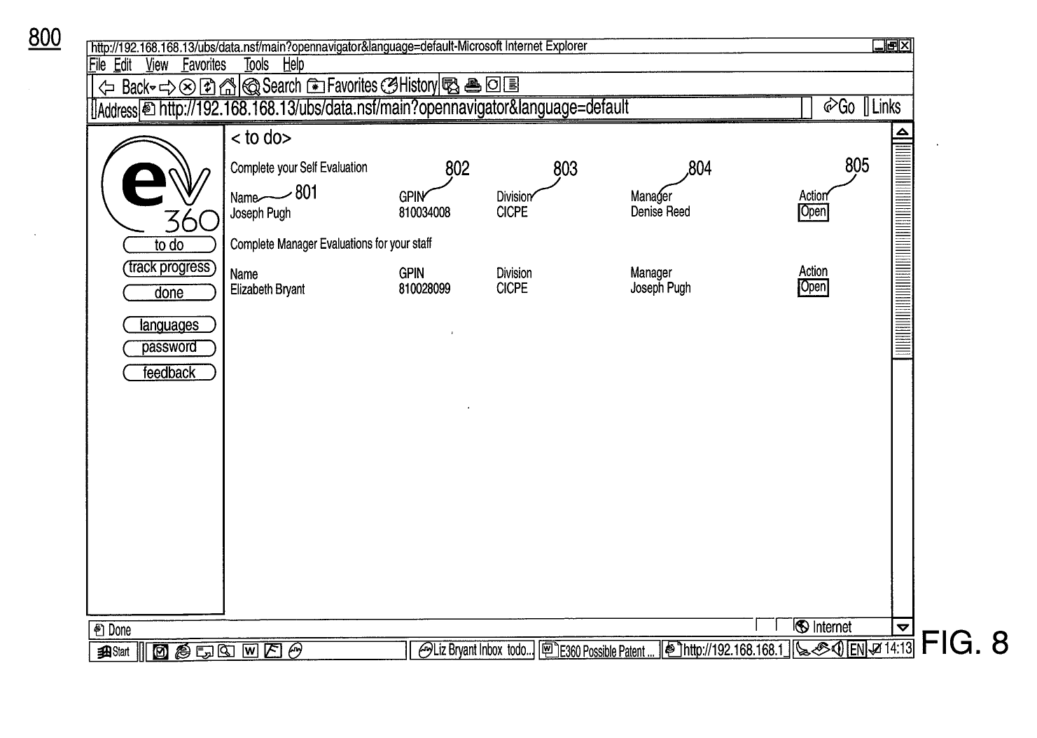

Evaluation management module 11 of system 1 monitors the progress of the 90 degree and 360 degree evaluations by accessing the evaluation information stored in evaluation data database 5 and reports on the status of such evaluations to the appropriate individuals. For example, evaluation management module 11 can retrieve from evaluation data database 5 all evaluations that a particular employee within an organization has yet to complete. Referring now to FIG. 8, there is shown a screenshot of a to do form 800 according to an exemplary embodiment in which the evaluations an employee has yet to complete is displayed. To do form 800 may display whether information regarding a self-evaluation the employee has yet to complete including the employee's name 801, ID number 802, division 803, manager 804 and the action 805 that is necessary to complete the self evaluation. In addition, to do form 800 displays similar information regarding any manager evaluations the employee has yet to complete. Furthermore, to do form 800 can be interactive so that the user can launch tasks required to complete or reject an evaluation task directly from to do form 800.

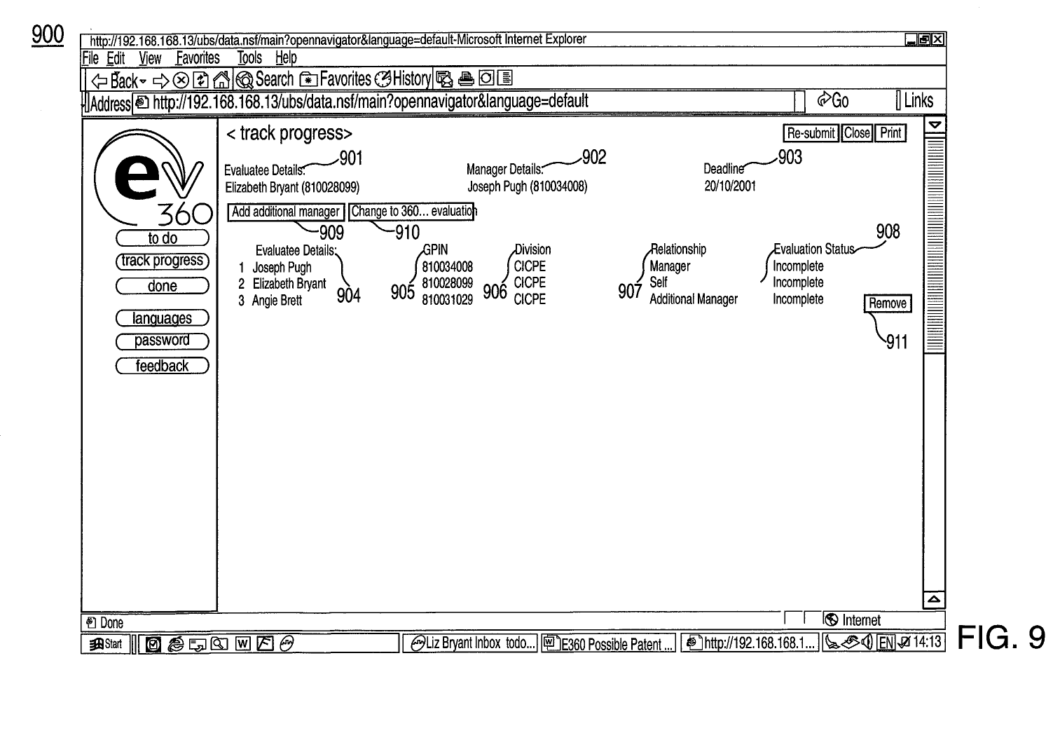

Evaluation management module 11 may also retrieve evaluation information from evaluation data database 5 to track the progress of an evaluation of a particular employee. Referring now to FIG. 9, there is shown a screenshot of a track progress form 900 according to an exemplary embodiment in which the progress of a particular employee evaluation is displayed. Track progress form 900 may display evaluatee details 901, such as the evaluatee's name and employee ID, manager details 902, such as the evaluatee's manager and the manager's employee ID, and the deadline for completing the evaluation 903. In addition, track progress form 900 lists evaluators names 904 that are to provide an evaluation for the particular evaluatee, the employee IDs of such evaluators 905, the division of each evaluator 906, the relationship each evaluator has to the evaluatee 907 and the evaluation status of each evaluation 908.

Track progress form 900 may also include programmable interface devices that can be used to add an additional manager to the evaluator list 909, change the particular evaluation to a 360 degree evaluation 910, remove an evaluator from the list of evaluators 911, as well as any other features to manage the evaluation process.

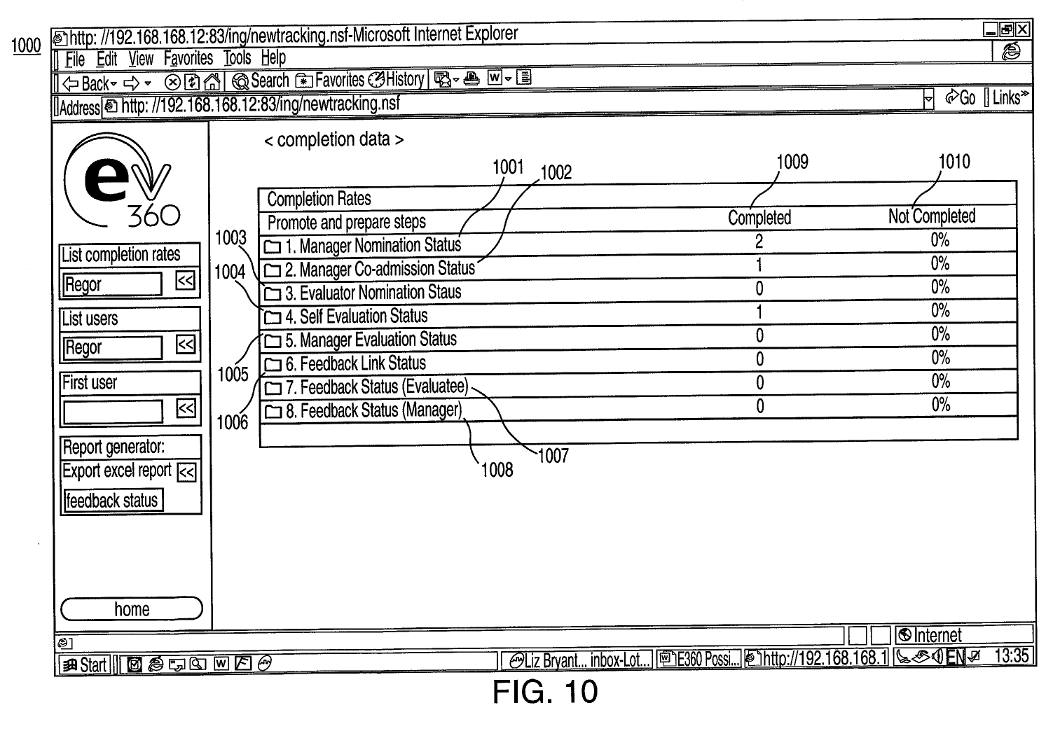

Referring now to FIG. 10, there is shown a screenshot of a completion data form 1000 according to an exemplary embodiment in which the overall status of evaluations throughout the organization can be monitored. In particular, completion data form 1000 allows an administrator to track the status of each phase of all the evaluations being conducted in the organization. In an exemplary embodiment, completion data form 1000 displays a manager nomination status line 1001 indicating the employees that have nominated a manager as an evaluator. A completed column 1009 and a percent (%) completed column 1010 indicates the number and percent of employees that have nominated managers as evaluators, respectively. Completion data form 1000 also displays a manager confirmation status 1002 line that indicates the number and percentage of manager's that confirmed their nomination as evaluators. An evaluator nomination status line 1003 is included that indicates the number and percent of employees that have nominated others, such as peers and direct reports, as evaluators. A self-evaluation status line 1004 is included that indicates the number and percentage of evaluatees that have completed their self-evaluation. A manager evaluation status line 1005 is included that indicates the number and percentage of managers that have completed their assigned manager evaluations. A feedback status line 1006 is included that indicates the number and percentage of evaluations that have been sent to evaluatees for the evaluatees comments. A feedback link status (evaluates) line 1007 and a feedback link status (manager) line 1008 are included that indicates the number and percentage of evaluations that have been signed off by evaluatees and managers, respectively. In addition, any other information regarding the status of the evaluation process may be displayed by completion data form 1000.

In an exemplary embodiment, upon activating each of status lines 1001-1008, such as by clicking on it with a computer mouse, a list of the information summarized by the particular one of status lines 1001-1008 is displayed. For example, by activating manager nomination status line 1001, a list of the employees that have nominated managers as evaluators is displayed. Accordingly, completion data form 1000 provides the administrator with a snapshot of the evaluation process throughput the organization as well as the ability to examine any aspect of the process in greater detail.

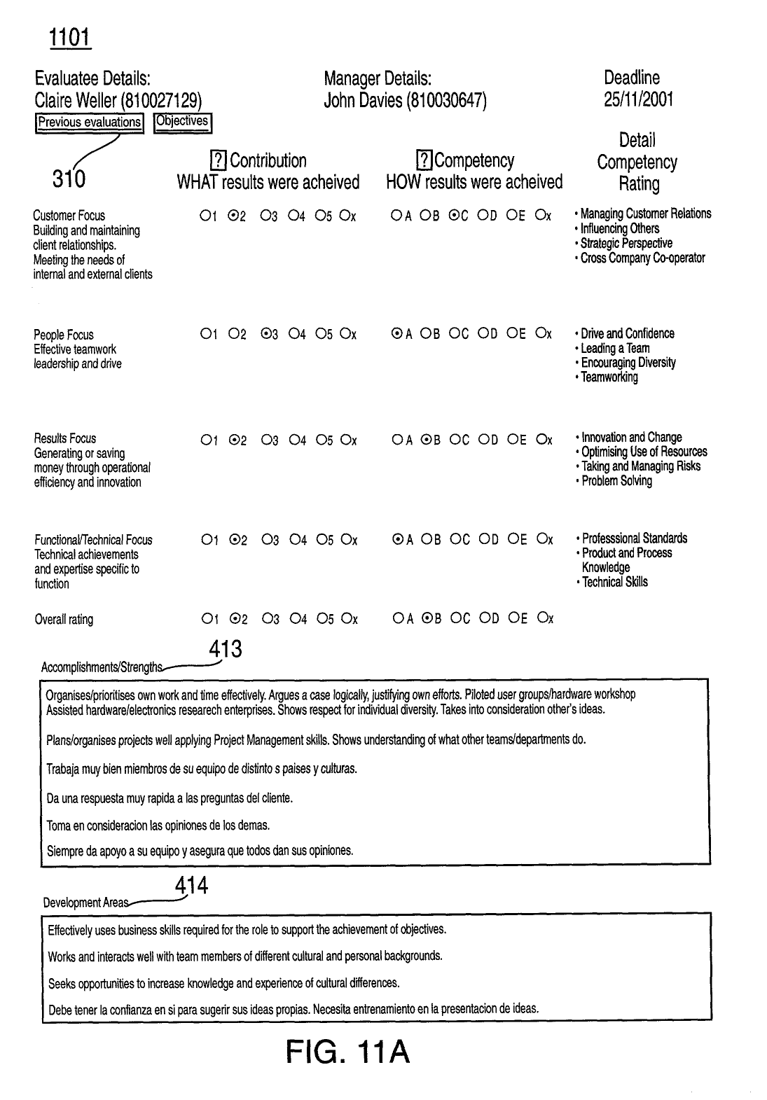

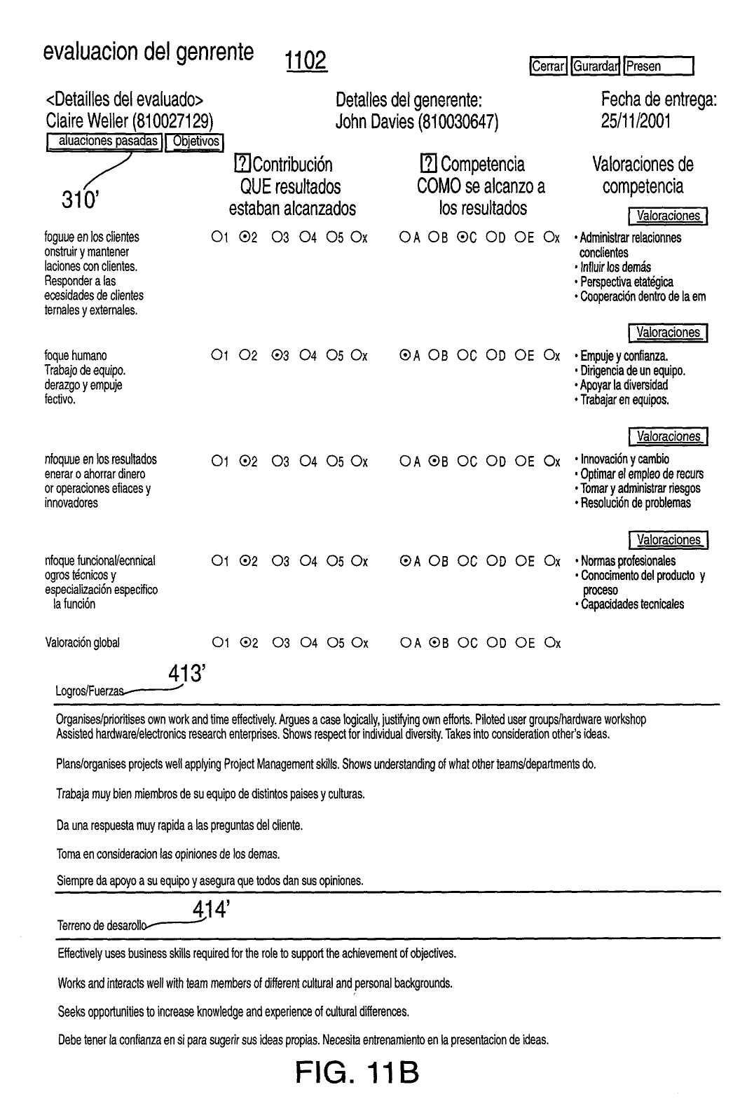

Because system 1 receives evaluation information from evaluators that are globally dispersed, the forms used to receive and present evaluation information must be adaptable to all of the different languages spoken by evaluators and evaluatees throughout the organization. To provide multilingual support, language manager 7 included in user interface 3 automatically converts all screen prompts and labels contained in all of the forms used in system 1 into the language selected by a particular user accessing system 1. Referring now to FIGS. 11a and 11b, there are shown screenshots of a multilingual feedback form 1101 and 1102, respectively, in which the same evaluation information is presented in different languages. For example, in multilingual feedback form 1101, all the prompts and labels, such as customer focus 310, are in English while in multilingual feedback form 1102, all the prompts and labels, such as label 310′, are in Spanish. Similarly, any other user-interface screen provided by system 1 may be presented in any selected language. Thus, a Spanish-speaking evaluator may select to enter evaluation information into a manager evaluation form having Spanish prompts and labels while the evaluatee may view an evaluation feedback form using a feedback form based on such evaluation information having English prompts and labels.

While prompts and labels of the forms may be tailored to the language selected by the user, information entered into Accomplishments/Strengths section 413, Development Areas section 414 and the Spanish equivalents 413′ and 414′ are maintained in the native language of the individual entering the information and are not translated into the language of the recipient viewing the information. For example, feedback information in Accomplishments/Strengths section 413, as well as the Spanish equivalent 413′, include comments in Spanish as well as English because those were the languages in which the comments were entered. The purpose of maintaining the comments in the commenting author's native language is so that the comments are accurately transmitted to the intended recipient and not obscured by inaccurate translations.

Accordingly, by providing multilingual support so that each user may select forms provided by system 1 having prompts and labels in the user's native language, PMM system 1 of the present invention can provide performance measurement and management services for diverse organizations.

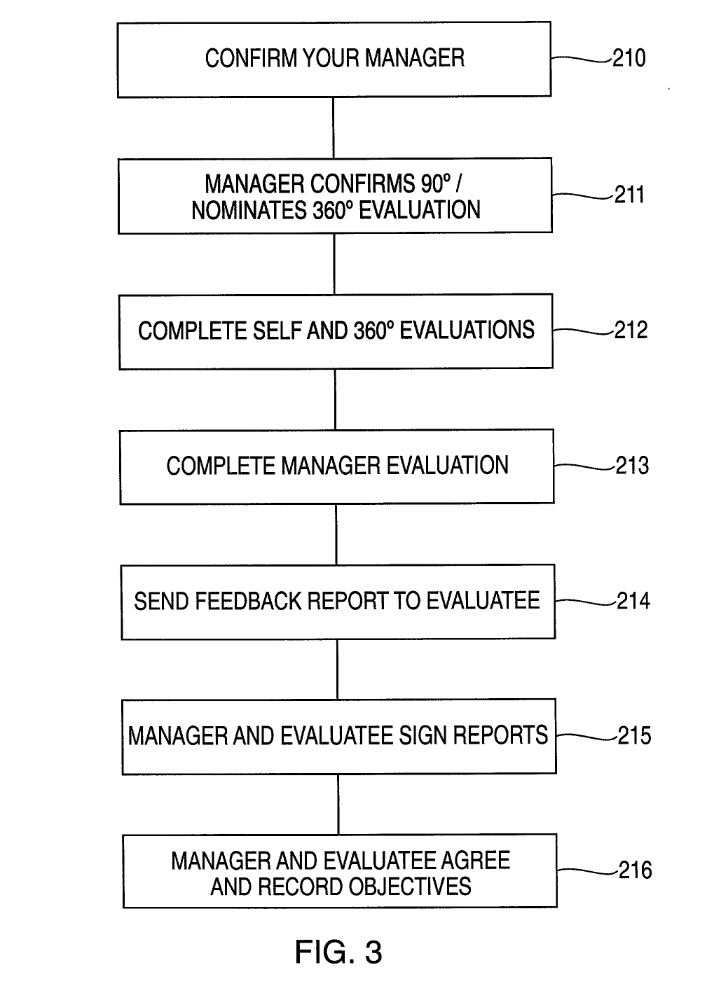

A PMM method according to the present invention can include computer automated steps for accomplishing an evaluation. Referring now to FIG. 3, there is shown a flowchart of an exemplary PMM process 200 that can be used to provide online evaluation and feedback, as well as objective or activity planning. An evaluatee, manager, or other interested party can access a computer screen that presents to the evaluatee, a manager associated with the evaluatee. The evaluatee can then confirm the associated manager 210.

The manager, in turn, can confirm a 90-degree evaluation or nominate a 360-degree evaluation relating to the evaluatee 211. A 90-degree evaluation can include an evaluation by the evaluatee and the evaluatee's manager. A 360-degree evaluation can additionally include evaluations from additional evaluators. The additional evaluators would typically include a combination of peers, internal clients, external clients, direct reports and, if appropriate, an additional manager. Evaluators can be chosen from a list of all registered users of the system.

The evaluatee and other designated evaluators can complete self and 360-degree evaluations 212. The manager can complete the manager evaluation 213. The system compiles all evaluations and sends a feedback report to the evaluatee 214. In one embodiment, a manager and other interested parties, such as a human resource representative can also receive feedback reports relating to the evaluatee. Reports can be available online to authorized personnel, or computer generated and forwarded to the appropriate parties. Appropriate parties can be designated as part of the evaluatee's profile. The manager and evaluatee can confirm receipt of the report by signing them 215, wherein a signature can be a physical signature on a hardcopy, a physical signature digitally captured, an electronic signature or password, or other means of confirming receipt. The manager and evaluatee can then proactively agree on objectives for an upcoming evaluation period and record the objectives in the computer system 216.

Different organizations may adopt different processes and value different criteria for measuring employee performance. For example, in some organizations, performance standards are based around organizational-wide competency clusters such as, by way of non-limiting example, a particular employee's customer focus, results focus and people focus. These competency clusters are further broken down into descriptions of specific behaviors (i.e., detailed competencies) and employees are assessed on how well they have demonstrated these behaviors and what they contributed to the organization. Such an organization may then use self-evaluation screenshot 300 in which the areas of performance to be evaluated is organized around the competency clusters. Alternatively, an organization may want to determine how effectively each employee performs various roles in the organizations. For such a review, each role within the organization is described by a set of distinct characteristics and behavior expectations and the level of experience and skills required for each role is identified. Yet other organizations may want to assess each employee's proficiency across a number of technical, business or interpersonal skills. An assessment of this nature may be used to identify skill/talent shortfalls in the organization and to effectively plan training, development, and hiring decisions around both current and future skill-set requirements.

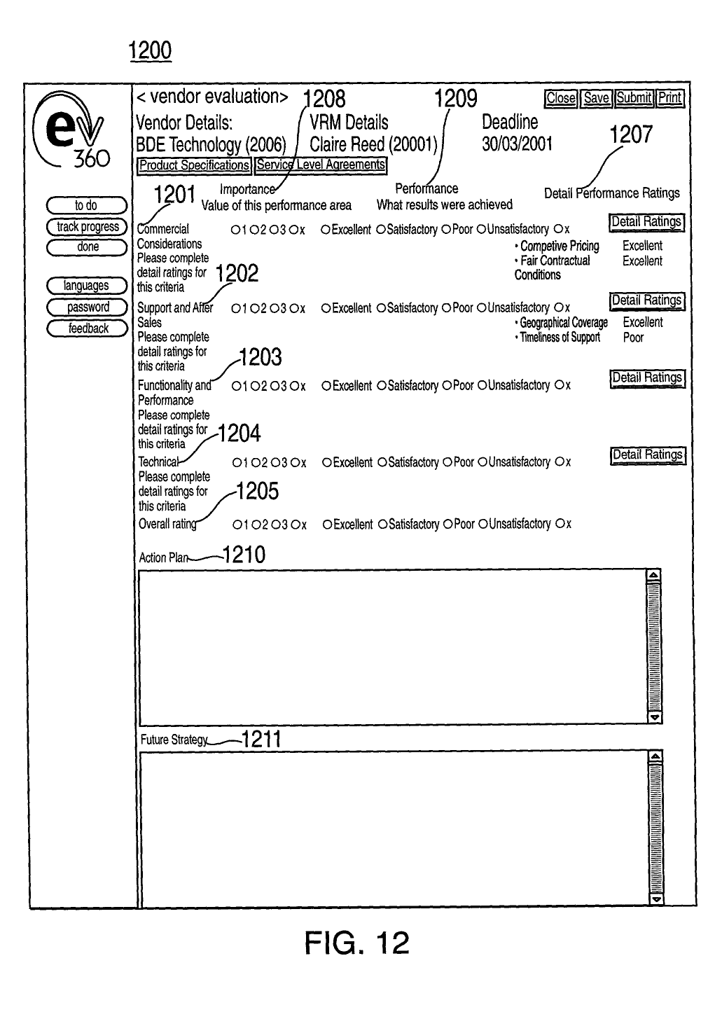

In addition to evaluating performance of employees, an organization may use system 1 to evaluate the performance of any individual or entity associated with the organization. Referring now to FIG. 12, there is shown a screenshot of a vendor evaluation form 1200 used to assess a particular vendor's performance in delivering a service or product to the organization. To perform such vendor appraisals, each aspect of the product or service is assigned a set of measurement criteria that can include relative importance weightings. For example, vendor evaluation form 1200 may include for assessment aspects relating to commercial considerations 1201, support and after sales 1202, functionality and performance 1203 and technical issues 1204. Vendor evaluation form 1200 may also have an importance rating 1208 in which the evaluator may place a weighting factor for each of the aspects being assessed. The evaluator may then appraise the particular vendor with respect to each of the aspects by selecting the appropriate performance rating 1209 (for example, excellent, satisfactory, poor or unsatisfactory). Each aspect being assessed may be further broken down into detail performance ratings 1207 in which the vendor's performance is assessed in greater detail. Vendor evaluation screen 1200 also includes an overall rating 1205 in which an overall rating of the vendor is calculated and provided. Also included in vendor evaluation screen 1200 are comments areas 1210 and 1211 for receiving comments regarding the vendor's action plan and future strategy, respectively, for the organization. Thus, by using vendor evaluation screen 1200 to solicit feedback regarding a vendor from people within the organization, an organization can generate a service/product performance review record for the particular vendor and compare the record against desired performance targets.

In addition to using system 1 to evaluate the performance of employees and vendors, system 1 may be used to evaluate, by way of non-limiting example, a product or service.

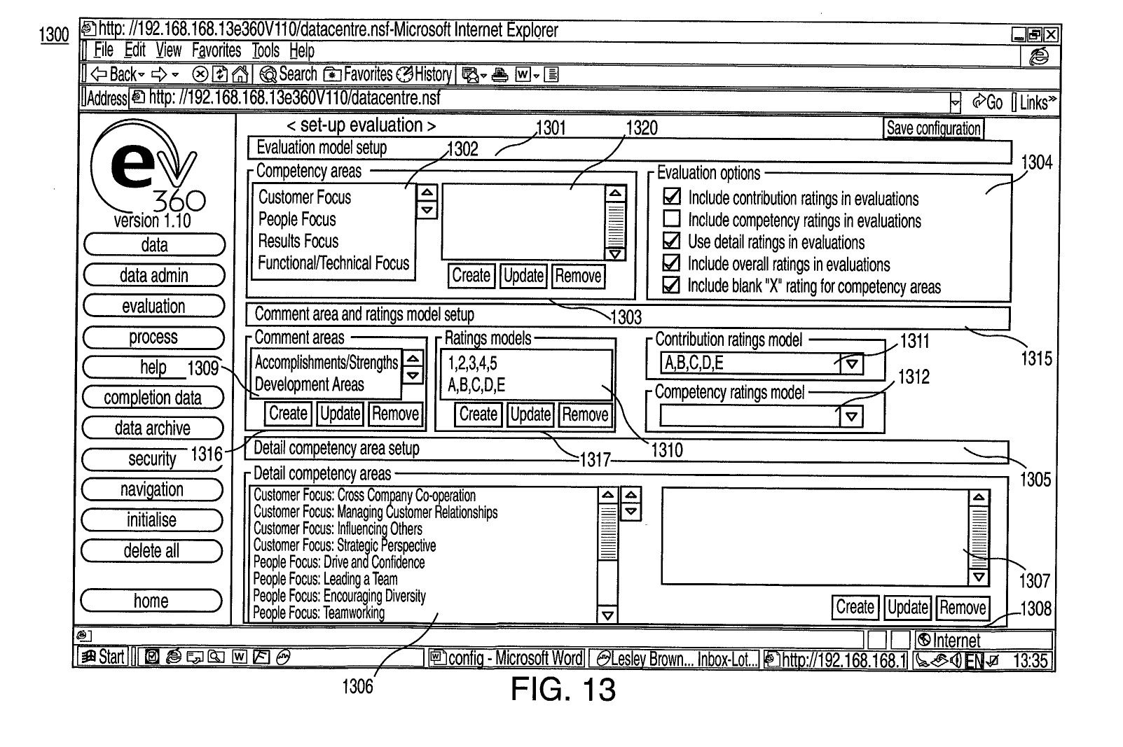

Referring now to FIG. 13, there is shown a screenshot of a set-up evaluation form 1300 that may be used to configure system 1 to evaluate employees according to different criteria or for using system 1 for evaluations other than employee evaluations. Accordingly, set-up evaluation form 1300 includes an evaluation model setup section 1301 that allows an administrator to select the performance assessment criteria 1302 that will form the basis of evaluations performed by system 1. For example, in the embodiment of FIG. 13, selected competency areas 1302 include Customer Focus, People Focus, Results Focus and Functional/Technical Focus. Competency areas 1302 may be selected by typing a desired competency to be evaluated into an input window 1320 and updating competency areas 1302 using edit buttons 1303. Evaluation model setup section 1301 also includes an evaluation options section 1304 in which various options defining the structure & content pertaining the evaluations such as, by way of non-limiting example, the use of contribution ratings, competency ratings, detail ratings overall ratings and “X” ratings, are selected. In this example, selecting these competency areas in set-up evaluation screen 1300 causes self-evaluation screen 300 (as well as other evaluation screens, as appropriate) to include areas 310, 311, 312 and 314, respectively, for evaluation.

If the use of detailed ratings is selected, then detailed performance assessment criteria 1306 to be evaluated may be selected via a detail competency area setup section 1305. For example, with respect to the customer focus area, detailed performance assessment criteria 1306 that may be selected are cross-company cooperation, managing customer relationships, influencing others and strategic perspective. Detailed performance assessment criteria 1306 may be selected, added or existing content amended by typing a desired detail competency to be evaluated into an input window 1307 and updating detail competency areas 1306 using edit buttons 1308. In this example, selecting these detail competency areas in set-up evaluation screen 1300 causes self-evaluation screen 300 (as well as other evaluation screens, as appropriate) to include the detail competency areas in Detail Competency Ratings section 323, for evaluation.

Set-up evaluation form 1300 also includes a comment areas and ratings model setup 1315 in which any number and description of comment areas and rating models may be setup. Comment area titles may be selected by typing a desired comment area title into an comment area window 1309 and activating input buttons 1316, as appropriate. In the embodiment of FIG. 13, Accomplishments/Strengths and Development Areas are comment area titles included comment area window 1309 that results in Accomplishments/Strengths comment area 413 and Development comment area 414 being included in various evaluation forms (for example, feedback form 400). A ratings model window 1310 provides the user with the ability to create the scoring methodology, in addition displays various default rating scales that may be used or amended to reflect specific scoring requirements. Such rating scales may include any desirable rating scale such as, by way of non-limiting example, Excellent, Satisfactory, Poor, Unsatisfactory, 1, 2, 3, 4, 5, and, A, B, C, D, E. A particular ratings model may be selected by typing a desired ratings model to be used by evaluators into rating model window 1310 and activating input buttons 1317, as appropriate. A particular ratings model may then be chosen for scoring performance against the chosen criteria for example contribution and competency (when these options are activated in evaluation options section 1304) by selected in contribution ratings model window 1311 and competency ratings model 1312, respectively, the desired one of ratings models included in ratings model window 1310.

Accordingly, a system and method is provided for performing and monitoring 90 degree and 360 degree employee performance appraisals in a geographically dispersed organization. Furthermore, set-up evaluation form 1300 enables an administrator to customize system 1 so that different assessment criteria, performance definitions, measurements and process requirements may be used in an evaluation process. In this way, system 1 performs as assessment engine that can be tailored to suit different assessment processes and criteria.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Computers 101-107, 131-132, 141-144 in a PMM system may be connected to each other by one or more network interconnection technologies. For example, dial-up lines, token-ring and/or Ethernet networks 110, 140, T1 lines, asynchronous transfer mode links, wireless links, digital subscriber lines (DSL) and integrated service digital network (ISDN) connections may all be combined in the network 100. Other packet network and point-to-point interconnection technologies may also be used. Additionally, the functions associated with separate processing and database servers in the host 150 may be integrated into a single server system or may be partitioned among servers and database systems that are distributed over a wide geographic area.

A number of embodiments of the present invention have been described. Nevertheless, it will be understood that various modifications may be made without departing from the spirit and scope of the invention. For example, evaluator or client computers 101-107 can comprise a personal computer executing an operating system such as Microsoft Windows™, Unix™, or Apple MacOS™, as well as software applications, such as a web browser. Evaluator computers 101-107 can also be terminal devices, a palm-type computer WEB access device that adhere to a point-to-point or network communication protocol such as the Internet protocol. Other examples can include TV WEB browsers, terminals, and wireless access devices (such as a 3-Com Palm VII organizer). A client computer may include a processor, RAM and/or ROM memory, a display capability, an input device and hard disk or other relatively permanent storage. Accordingly, other embodiments are within the scope of the following claims.

What is claimed is:

1) A computer-implemented method for providing performance measurement of an evaluatee, wherein the method comprises:
accessing an online performance measurement program on a distributed network access device;
electing an online 90 degree or 360 degree evaluation;
completing an online self evaluation;
completing the elected evaluation;
aggregating the results of the evaluations; and
sending feedback relating to the evaluation to the evaluatee.

2) The method of claim 1 additionally comprising setting objectives for an evaluation period and recording the objectives in the computer implementing the system.

3) The method of claim 1 additionally comprising applying a digital signature to a report containing the aggregated results.

4) The method of claim 1 additionally comprising listing on a to do list outstanding tasks relating to completion of the performance measurement.

5) The method of claim 1 additionally comprising linking compensation processes to the evaluation.

6) The method of claim 1 additionally comprising linking promotion processes to the evaluation.

7) The method of claim 1 additionally comprising listing completed tasks.

8) The method of claim 1 wherein a interaction with the computer system implementing the performance measurement can be accomplished in multiple languages.

9) The method of claim 1 additionally comprising selecting evaluators from a list of appropriate personnel relative to the evaluatee.

10) The method of claim 1 wherein the evaluations include contribution and competency categories.

11) The method of claim 10 wherein the competency category comprises detail ratings.

12) A computer system for providing performance measurement of an evaluatee, the system comprising:
a computer server accessible with a network access device via a communications network; and
executable software stored on the server and executable on demand via the network access device, the software operative with the server to cause:
access an online performance measurement program on a distributed network access device;
elect an online 90 degree or 360 degree evaluation;
complete an online self evaluation;
complete an elected evaluation;
aggregate the results of the evaluations; and
send feedback relating to the evaluation to the evaluatee.

13) The computer system of claim 12 wherein the network access device comprises a computer.

14) The computer system of claim 13 wherein the communication network conforms to the transmission control protocol/internet protocol.

15) The computer system of claim 12 wherein the computer communication network comprises an intranet.

16) The computer communications system of claim 12 additionally comprising a WEB interface for accessing the executable software stored on the server storage medium.

17) Computer executable program code residing on a computer-readable medium, the program code comprising instructions for causing the computer to:
access an online performance measurement program on a distributed network access device;
elect an online 90 degree or 360 degree evaluation;
complete an online self evaluation;
complete an elected evaluation;
aggregate the results of the evaluations; and
send feedback relating to the evaluation to the evaluatee.

18) The computer executable program of claim 17 wherein the computer communications network is a Transmission Control Protocol/Internet Protocol network.

19) A computer data signal embodied in a digital data stream comprising data including, wherein the computer data signal is generated by a method comprising the steps of:
accessing an online performance measurement program on a distributed network access device;
electing an online 90 degree or 360 degree evaluation;
completing an online self evaluation;
completing the elected evaluation;
aggregating the results of the evaluations; and
sending feedback relating to the evaluation to the evaluatee.

20) A computer data signal as in claim 19 wherein the signal generated adheres to the transmission control protocol/internet protocol.

21) A system for providing a performance evaluation, comprising:
an interface module, said interface module presenting to an evaluator an evaluation form in a first language, said evaluator inputting evaluation information regarding an evaluatee into said evaluation form;
an evaluation data database for storing said evaluation information; and
a feedback generator retrieving said evaluation information from said evaluation data database and placing said evaluation information into a feedback form;
wherein said interface module presents said feedback form to said evaluatee in a second language.

22) The system of claim 21, wherein said evaluator inputs comments in said first language and said feedback form is presented to said evaluatee in said second language and said comments in said first language.

23) The system of claim 21, wherein said evaluatee inputs comments in said second language, said feedback form is presented to said evaluator in said first language and said comments in said second language.

24) The system of claim 21, further comprising an evaluation management module for monitoring said evaluation information in said evaluation data database and generating status information regarding said performance evaluation.

25) The system of claim 24, wherein said status information is to do information.

26) The system of claim 24, wherein said status information is completion data information.

27) The system of claim 24, wherein said status information is communicated via electronic mail.

28) A method for providing a performance evaluation, comprising the steps of:
presenting to an evaluator an evaluation form in a first language,
receiving from said evaluator evaluation information regarding an evaluatee via said evaluation form;
storing said evaluation information into an evaluation data database;
retrieving said evaluation information from said evaluation data database;
placing said evaluation information into a feedback form; and
presenting said feedback form to said evaluatee in a second language.

29) The method of claim 28, further comprising the steps of:
receiving from said evaluator comments in said first language; and
presenting said feedback form to said evaluatee in said second language and said comments in said first language.

30) The method of claim 28, further comprising the steps of:
receiving from said evaluatee comments in said second language; and
presenting said feedback form to said evaluator in said first language and said comments in said second language.

31) The method of claim 28, further comprising the steps of:
monitoring said evaluation information in said evaluation data database; and
generating status information regarding said performance evaluation.

32) The method of claim 31, wherein said status information is to do information.

33) The method of claim 31, wherein said status information is completion data information.

34) The method of claim 31, wherein said status information is communicated via electronic mail.

35) A system for providing an evaluation, comprising:
a plurality of assessment criteria;
a ratings scale for rating an evaluatee's performance with respect to said plurality of assessment criteria;
an assessment engine for storing and presenting said rating information; and
a configuration tool for modifying said plurality of assessment criteria and said ratings scale.

36) The system of claim 35, wherein said plurality of assessment criteria includes detailed performance criteria for assessment and said configuration tool modifies said detailed performance criteria.

37) The system of claim 35, wherein said evaluatee is an employee.

38) The system of claim 35, wherein said evaluatee is a vendor.

39) The system of claim 35 wherein said evaluatee is a product.

40) The system of claim 35 wherein said evaluatee is a service.

41) The system of claim 35, wherein said rating of said evaluatee includes said evaluatee's contribution with respect to at least one of said plurality of assessment criteria.

42) The system of claim 35, wherein said rating of said evaluatee includes said evaluatee's performance with respect to at least one of said plurality of assessment criteria.

43) The system of claim 35, wherein said rating of said evaluatee includes an importance measure with respect to at least one of said plurality of assessment criteria.

44) The system of claim 35, further comprising at least one comment area for receiving comment information and wherein said configuration tool modifies said at least one comment area.

45) A method for providing an evaluation, comprising:
selecting a plurality of assessment criteria;
selecting a ratings scale for rating an evaluatee's performance with respect to said plurality of assessment criteria;
receiving rating information for said evaluatee based on said plurality of assessment criteria and said ratings scale;
presenting a assessment of said evaluatee based on said rating information.

46) The method of claim 45, wherein said plurality of assessment criteria can include detailed performance assessment criteria and further comprises the step of
selecting said detailed criteria.

47) The method of claim 45, wherein said evaluatee is an employee.

48) The method of claim 45, wherein said evaluatee is a vendor.

49) The method of claim 45 wherein said evaluatee is a product.

50) The method of claim 45 wherein said evaluatee is a service.

51) The method of claim 45, wherein said rating information of said evaluatee includes said evaluatee's contribution with respect to at least one of said plurality of assessment criteria.

52) The method of claim 45, wherein said rating information of said evaluatee includes said evaluatee's performance with respect to at least one of said plurality of assessment criteria.

53) The method of claim 45, wherein said rating of said evaluatee includes an importance measure with respect to at least one of said plurality of assessment criteria.

54) The method of claim 45, further comprising the step of:
selecting at least one comment area for receiving comment information.
